(19) United States
(12) Patent Application Publication
(10) Pub. No.: US 2013/0025439 A1
(43) Pub. Date: Jan. 31, 2013

(54) Firearm Blast Shield

(71) Applicant: Kevin Orton, (US)

(72) Inventor: Kevin Orton, (US)

(21) Appl. No.: 13/560,804

(22) Filed: Jul. 27, 2012

Related U.S. Application Data
(60) Provisional application No. 61/512,049, filed on Jul. 27, 2011.

(51) Int. Cl. F41A 21/34; F15C 1/16

(52) U.S. Cl. 89/14.2; 137/808

(57) ABSTRACT

An exhaust reflector for cooling and reducing the velocity of firearm, internal combustion engine, and other exhaust gases, and controlling the dispersion of exhaust debris away from the operator.

This invention claims priority to U.S. application No. 61/512,049, filed 27 Jul. 2011.

### BACKGROUND OF THE INVENTION

When firearms are discharged, a large amount of soot and particulate matter and hot air is released out the end of the muzzle. The particulate matter is hot, and can be uncomfortable or even burn if the firearm is discharged in close quarters. The particulate matter exits at a high velocity and pressure, and can spread outward in all directions as the exhaust gas exits the muzzle. The fire flash can also negatively impact the operators eyes and sight.

It is desirable to contain the particulate matter so that it does not disburse over a wide range or near the operator. Also to reduce the velocity of gases and particulate matter exiting the firearm muzzle. Also to provide for the safe dispersion of firearm flash energy, without it reaching the eyes of the firearm operator. This invention provides such a means.

### BRIEF DESCRIPTION OF THE DRAWINGS

FIG. 1 shows the invention as fitted to a firearm.

FIG. 2 is a cutaway side view of the invention.

FIG. 3 shows dimensional scaling.

FIG. 4 shows an alternate embodiment of the invention.

FIG. 5 is an end view detail of one embodiment of the present invention.

FIG. 6 is functional details of the embodiment of FIG. 5.

### DETAILED DESCRIPTION OF THE DRAWINGS

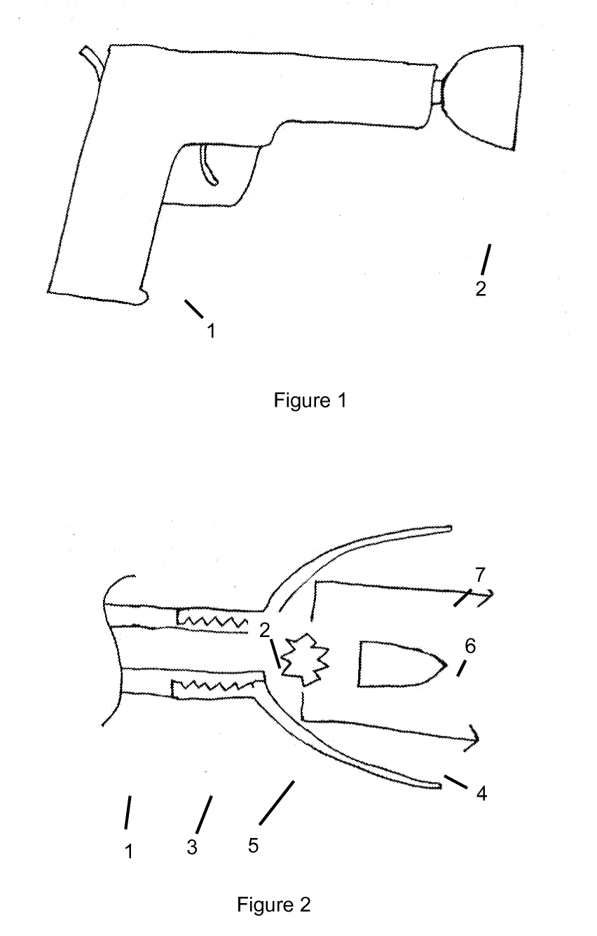

In FIG. 1, (1) a side view of a firearm of conventional construction is shown. The firearm can take many of known various shapes and configurations, including pistols, rifles, machine guns, artillery, cannons, projectile and missile launchers, and other such devices. A gas reflector shield (reflector) (2) of the type of the present invention is shown fitted to the firearm (1). The reflector is generally mounted at the muzzle end of the firearm, where the projectile exists.

In FIG. 2, the reflector (2) is mounted to the firearm (1) through various conventional means, such as threads (3). When the bullet or other projectile (4) exits the barrel of the firearm, concentrated blast charge (5) follows behind the bullet.

The blast charge is initially concentrated in the area the size of the barrel. As the blast charge, with hot particulate matter exist the muzzle, it seeks to expand outward in all directions. In the present invention, the reflector (2) contains the blast charge (5), and directs air motion outward (6) toward the target. The blast charge exits the reflector at the opening 7. In the present invention, the blast charge is redirected and contained while within the reflector (2). By the time the blast charge can exit the reflector, the concentrated blast charge has become focused outward away from the operator and expanded to an area many times it's original initial size. Thus the reflector acts to direct and focus the blast charge downrange and toward the target. (away from the operator).

In the present invention, the interior surface of the reflector is preferably concave. The concave reflector is inwardly reflective. The concave construction provides a large rapidly expanding initial opening for the gas at the point of gas entry (2), and then gradually tapers to generally more parallel sides at the open end (7) that are more concavely perpendicular to the sides at initial gas entry point (2). The concave construction provides advantages in that it simultaneously focuses all points of the exiting blast charge in a single direction. Gas enters the reflector, and expands rapidly initially (2). However, the gas then reaches the outer parallel surfaces of the reflector, where it can no longer expand, and in fact a pressure wave is created inside the reflector when the gas can no longer expand and hits the static existing (external)air. That causes secondary (momentary) high pressure to develop inside the reflector. The high pressure inside the reflector is then reflected back onto itself inside the reflector in a singular point which aligns the blast charge directional in the direction of the open end of the reflector. The preferably concave parabolic reflector shape of the present invention helps to align the gas pressure and debris and fire flash in a directional manner. When the aligned gas escapes, the blast debris is highly directional, and extends along an axis parallel to the projectile travel, away from the operator. Large aspects of the fire flame are also dispersed in a manner that prevents the bright light flash from reaching the operator eyes. There is little peripheral gas dispersal, and all the blast is transmitted forward, away from the operator and toward the target. In this way, the present invention obtains much reduced blast charge for the operator, shielding the operator with a relatively small size device, and directs the blast toward the target.

The velocity of the air exiting the reflector is also greatly reduced. For example, if the reflector is just three times the bullet diameter, the total exit area of the reflector will be nine times the bullet diameter, and the gas velocity is generally reduced to one-ninth that which it would be without the reflector.

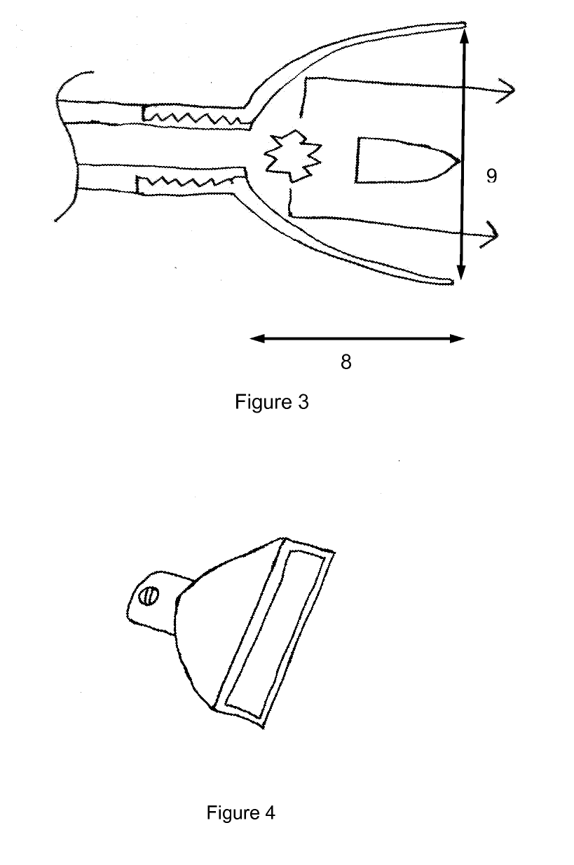

In FIG. 3, (8) shows the length of the interior dimension of the reflector, and (9) shows the diameter of the open end of the reflector. In the preferred embodiment, the length (8) of the reflector is at least 1.2 to 1.5 times, and preferably up to at least about 2 to 2.5 or 3 times the diameter (9) of the reflector. However, shorter or even longer length/width ratios may still be used and still obtain advantages.

FIG. 4 shows an alternate embodiment of the invention. In FIG. 4, the reflector is flattened. Flattening reduces the efficiency of the reflector some, but permits retro-fitting to a firearm while providing additional sight clearance.

The actual reflector may be made out of conventional materials, such as aluminum or steel, or even plastic resins, particularly resins that are fiber filled, or other materials. The blast reflector and energy director may be attached to the firearm through various conventional means, such as screw on threads, a clamp collar, set screws, and so on. or other means, and can be permanently attached or removable. It can be integrated into the barrel as one piece. The present invention generally obtains a free-flowing design that is not subject to clogging.

The present invention is not limited to hand held firearms. It may also be implemented on all sorts of cannons, tanks, rocket launchers, artillery, and other similar devices, which are all meant to be included in the description “firearm”. The reflector may be sold or manufactured as a retrofit to existing firearms.

Advanced reflector designs may be used that allow compensation for lift or windage built right into the reflector. Such effects may be accomplished for example by non-uniform symmetries and ports or vents in the reflector housing. The invention is also particularly useful on automatic fire machine guns. Artillery and other firearm retrofits can be accomplished with relatively simple clamp on or other mount reflectors.

The system does also help to contain flames at the muzzle, and to keep soot and hot powder residues away from and out of the eyes of the operator.

### Vortex Vanes

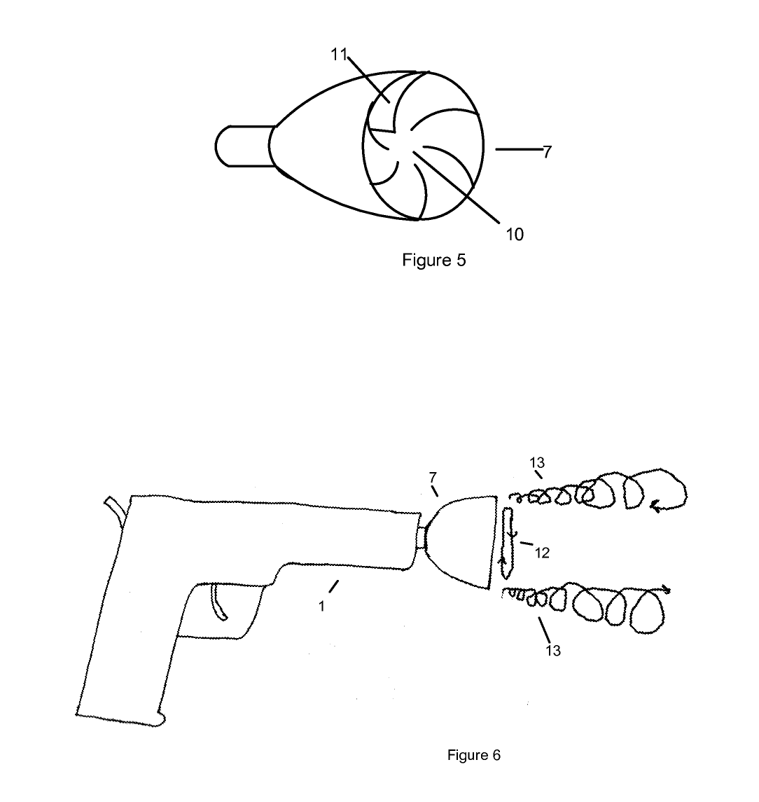

In another embodiment of the present invention, vanes may be included on the inside of the reflector. Referring to FIG. 5, FIG. 5 is an end view, where the projectile or gas charge exits. FIG. 5, 7 shows the reflector cone within which gas is allowed to expand. There is a hole in the center 10 where the projectile passes through reflector. The reflector cone includes spiraling vanes 11, which function as rotational gas directors, and which serve to rotate the gas in a circular swirling motion into a rotational pattern as it expands and travels outward.

Referring to FIG. 6, a firearm 1 is fitted with the reflector cone 7. Inside the reflector are the spiral vanes of FIG. 5-11. As the blast charge exits the cone, the blast charge has been directed in a circular rotating pattern 12 by the vanes FIG. 5-11. When exiting the reflector, the rotating air then hits the stationary outside air, and generally forms a vortex 13 at the interface. The circular rotating pattern and vortex works to dissipate the blast energy in the local air, creating agitation which heats the air in a broad area, reducing hot spots and dissipating energy and preventing the free propagation of the blast debris in an outward manner. The effect can also be used to diminish or reduce the blast debris. It may also be fitted to other exhausts such as automobile exhausts.

The vortex exhaust may be fabricated using any number of known means, for example (without limit), by metal stamping or die casting or injection molding the vortex cone.

The number of vanes can vary for example from 1-2 to 4 to 6 or 8 or more vanes.

The reflector was tested on an exhaust system with dramatic results. One test was on a motorcycle exhaust. This was a 250 cc motorcycle operated at approximately 7000 rpm, which gives an exhaust gas volume well in in excess of 15 liters per second coming out of a 1.3″ diameter exhaust tube. The reflector cone had an inlet size of 1.3″ and an outlet size of 2.9″, giving an exhaust exit area of approximately 5 times the inlet size. The reflector had an inward concave parabolic shape. In use, when the reflector was fitted, the exhaust gas velocity was greatly reduced, from a powerful jet, to a fairly calm smooth stream. The airflow also felt much less turbulent, and more laminar and even at a distance of 12″ from the exhaust. The spiral vanes may be fitted also to the end of an internal combustion engine exhaust, where the exhaust leaves the containment pipe and enters free air.

The reflector cone and/or vortex or other internal ridges may be adapted to fit on a firearm muzzle. If the vortex direction is aligned correctly (opposite the barrel rifling), it can help stabilize the firearm from twisting motion inducted by the spinning projectile.

The reflector may also help to diminish the appearance of fire flash for the firearm operator, while still allowing working area for the flash to dissipate.

What is claimed is:

1) A device adapted to the muzzle end of the barrel of a firearm, said device including an inwardly concave reflector serving to direct blast waves coming out of the muzzle away from the operator of the firearm.

2) A gun muzzle fitting that expands and spins the exhaust air in a circular manner before releasing the air into the environment.

3) A engine exhaust fitting that expands and spins the exhaust air in a circular manner before releasing the air into the environment.
